(19) United States
(12) Patent Application Publication
(10) Pub. No.: US 2025/0215280 A1
(43) Pub. Date: Jul. 3, 2025

(54) ENERGY RAY-CROSSLINKABLE ADHESIVE COMPOSITION, CROSSLINKED ADHESIVE, ADHESIVE SHEET, AND PRODUCTION METHODS THEREFOR

(71) Applicant: LINTEC CORPORATION, Tokyo (JP)

(72) Inventors: Kenta YAMAZAKI, Saitama-shi (JP); Shinya SUZUKI, Toda-shi (JP)

(73) Assignee: LINTEC CORPORATION, Tokyo (JP)

(21) Appl. No.: 18/851,282

(22) PCT Filed: Mar. 29, 2023
(86) PCT No.: PCT/JP2023/012715

§ 371 Date: Sep. 26, 2024

(30) Foreign Application Priority Data
Mar. 31, 2022 (WO) PCT/JP2022/016671

(51) Int. Cl. C09J 7/38; C08J 3/20; C09J 5/00; C09J 133/08

(52) U.S. Cl. CPC C09J 7/385; C08J 3/203; C09J 5/00; C09J 133/08; C09J 2301/302; C09J 2301/416; C09J 2433/00

(57) ABSTRACT

An energy-ray-crosslinkable pressure-sensitive adhesive composition may contain a (meth)acrylic resin (A) having no energy ray crosslinkability and an acrylic resin (B) having energy ray crosslinkability. A pressure-sensitive adhesive sheet may use such a energy-ray-crosslinkable pressure-sensitive adhesive composition. A crosslinked pressure-sensitive adhesive may be obtained by subjecting the energy-ray-crosslinkable pressure-sensitive adhesive composition to energy ray crosslinking. A pressure-sensitive adhesive sheet may use the crosslinked pressure-sensitive adhesive.

### TECHNICAL FIELD

The present invention relates to an energy-ray-crosslinkable pressure-sensitive adhesive composition, a crosslinked pressure-sensitive adhesive, pressure-sensitive adhesive sheet, and methods for producing these.

### BACKGROUND ART

Pressure-sensitive adhesive sheets are used in a wide range of industrial fields, for example, label applications for displaying various types of information; applications for fixing or temporarily fixing various components in fields such as office automation equipment, household electrical appliances, automobiles, and construction; and masking applications.

In such circumstances, hot-melt pressure-sensitive adhesives have been widely used as pressure-sensitive adhesives used in pressure-sensitive adhesive sheets and can be easily applied to substrates or the like by heat-melting without using a solvent, and thus have an advantage of being able to reduce the environmental load in production of pressure-sensitive adhesive sheets.

As a hot-melt pressure-sensitive adhesive, for example, a synthetic rubber-based hot-melt pressure-sensitive adhesive is widely known. In addition, needs for environmental load reduction have increased and, in recent years, acrylic hot-melt pressure-sensitive adhesives have been developed (e.g., Patent Document 1).

There are cases where a pressure-sensitive adhesive, not only for a hot-melt pressure-sensitive adhesive, is required to have cohesive strength, and one of the methods to impart cohesive strength is a method of crosslinking a pressure-sensitive adhesive by energy ray irradiation. For example, Patent Documents 2 and 3 describe a pressure-sensitive adhesive in which a hydrocarbon of an acrylic resin is withdrawn by a hydrogen-withdrawing photoinitiator, a radical is generated in the acrylic resin, and a crosslinking reaction is proceeded by a coupling reaction of the generated radical.

### CITATION LIST

### Patent Literature

Patent Document 1: JP 2021-130760 A
Patent Document 2: JP 2011-140576 A
Patent Document 3: JP 2016-169304 A

### SUMMARY OF INVENTION

### Technical Problem

However, in a case where a hydrogen-withdrawing photoinitiator having a low molecular weight is used similarly to pressure-sensitive adhesives of Patent Documents 2 and 3, a low-molecular-weight substance formed by the radical coupling reaction of the photoinitiator at the time of the crosslinking reaction remains, and thus there is a risk of staining of an adherend, such as attachment marks (cloudiness, ghost) of a pressure-sensitive adhesive sheet, originating from a low-molecular-weight substance remaining on the adherend when the pressure-sensitive adhesive sheet is adhered to the adherend and then removed.

The present invention has been made in view of the problems described above, and an object of the present invention is to provide an energy-ray-crosslinkable pressure-sensitive adhesive composition capable of forming a pressure-sensitive adhesive that has good adhesive strength and that causes little staining of an adherend; a pressure-sensitive adhesive sheet obtained using the energy-ray-crosslinkable pressure-sensitive adhesive composition; a crosslinked pressure-sensitive adhesive obtained by energy-ray-crosslinking the energy-ray-crosslinkable pressure-sensitive adhesive composition and a method for producing the crosslinked pressure-sensitive adhesive; and a pressure-sensitive adhesive sheet obtained using the crosslinked pressure-sensitive adhesive and a method for producing the pressure-sensitive adhesive sheet.

### Solution to Problem

The present inventors have found that the aforementioned problems can be solved by using a (meth)acrylic resin and an acrylic resin having a specific structure and have completed the present invention.

That is, the present invention provides the following [1] to [11].

[1] An energy-ray-crosslinkable pressure-sensitive adhesive composition containing a (meth)acrylic resin (A) having no energy ray crosslinkability and an acrylic resin (B) having energy ray crosslinkability.

[2] The energy-ray-crosslinkable pressure-sensitive adhesive composition according to [1] above, where a content of the acrylic resin (B) having energy ray crosslinkability is from 5 to 90 parts by mass per 100 parts by mass of the (meth)acrylic resin (A) having no energy ray crosslinkability.

[3] The energy-ray-crosslinkable pressure-sensitive adhesive composition according to [1] or [2] above, where the acrylic resin (B) having energy ray crosslinkability is an acrylic resin having a benzophenone structure in a side chain.

[4] The energy-ray-crosslinkable pressure-sensitive adhesive composition according to any one of [1] to [3] above, where the glass transition temperature of the (meth)acrylic resin (A) having no energy ray crosslinkability is 0° C. or lower, and the glass transition temperature of the acrylic resin (B) having energy ray crosslinkability is 0° C. or lower.

[5] A pressure-sensitive adhesive sheet including an energy-ray-crosslinkable pressure-sensitive adhesive composition layer containing the energy-ray-crosslinkable pressure-sensitive adhesive composition according to any one of [1] to [4] above on a substrate or a release liner.

[6] A method for producing the pressure-sensitive adhesive sheet according to [5] above,
the energy-ray-crosslinkable pressure-sensitive adhesive composition being obtained by melt-kneading the (meth)acrylic resin (A) having no energy ray crosslinkability and the acrylic resin (B) having energy ray crosslinkability; and
the energy-ray-crosslinkable pressure-sensitive adhesive composition layer being formed by applying the energy-ray-crosslinkable pressure-sensitive adhesive composition in a melted state on the substrate or the release liner.

[7] A crosslinked pressure-sensitive adhesive obtained by irradiating the energy-ray-crosslinkable pressure-sensitive adhesive composition according to any one of [1] to [4] above with an energy ray.

[8] A method for producing the crosslinked pressure-sensitive adhesive according to [7] above,
the method including irradiating the energy-ray-crosslinkable pressure-sensitive adhesive composition with an energy ray.

[9] A pressure-sensitive adhesive sheet including a pressure-sensitive adhesive layer containing the crosslinked pressure-sensitive adhesive according to [7] above on a substrate or a release liner.

[10] A method for producing the pressure-sensitive adhesive sheet according to [9] above, the method including:
forming an energy-ray-crosslinkable pressure-sensitive adhesive composition layer containing the energy-ray-crosslinkable pressure-sensitive adhesive composition on the substrate or the release liner; and
irradiating the energy-ray-crosslinkable pressure-sensitive adhesive composition layer with an energy ray.

[11] A method for producing the pressure-sensitive adhesive sheet according to above,
the energy-ray-crosslinkable pressure-sensitive adhesive composition being obtained by melt-kneading the (meth)acrylic resin (A) having no energy ray crosslinkability and the acrylic resin (B) having energy ray crosslinkability; and
the energy-ray-crosslinkable pressure-sensitive adhesive composition layer being formed by applying the energy-ray-crosslinkable pressure-sensitive adhesive composition in a melted state on the substrate or the release liner.

### Advantageous Effects of Invention

According to the present invention, an energy-ray-crosslinkable pressure-sensitive adhesive composition that can form a pressure-sensitive adhesive that causes little staining of an adherend while good adhesive strength is achieved; a pressure-sensitive adhesive sheet containing the energy-ray-crosslinkable pressure-sensitive adhesive composition; a crosslinked pressure-sensitive adhesive obtained by crosslinking the energy-ray-crosslinkable pressure-sensitive adhesive composition using an energy ray, and a method for producing the same; and a pressure-sensitive adhesive sheet containing the crosslinked pressure-sensitive adhesive, and a method for producing the same are provided.

### BRIEF DESCRIPTION OF DRAWINGS

FIG. 1 is a schematic cross-sectional view illustrating an example of a configuration of a pressure-sensitive adhesive sheet according to the present invention.

FIG. 2 is a schematic cross-sectional view illustrating another example of a configuration of a pressure-sensitive adhesive sheet according to the present invention.

FIG. 3 is a schematic cross-sectional view illustrating another example of a configuration of a pressure-sensitive adhesive sheet according to the present invention.

### DESCRIPTION OF EMBODIMENTS

In the present specification, the lower and upper limits of a preferable numerical range (for example, a range of content) described in series can each be independently combined. For example, from the description “preferably from 10 to 90, more preferably from 30 to 60”, the “preferred lower limit (10)” and the “preferred upper limit (60)” can be combined as “from 10 to 60”.

In the present specification, the “energy ray” means an electromagnetic wave or a charged particle beam having an energy quantum, and examples include ultraviolet rays, radiation, and electron beams. The ultraviolet rays can be irradiated by using, for example, an electrodeless lamp, a high-pressure mercury lamp, a metal halide lamp, or a UV-LED as an ultraviolet ray source. The electron beam can be generated by an electron beam accelerator or the like and irradiated. Note that the energy ray in an embodiment of the present invention is preferably an ultraviolet ray among those described above.

In the present specification, “energy-ray-crosslinkable” refers to a property of forming a crosslinked structure by irradiation with an energy ray.

In the present specification, the term “(meth)acrylic” is used as a term meaning either one or both of “acrylic” and “methacrylic”. Similarly, the term “(meth)acrylate” is used as a term meaning either one or both of “acrylate” and “methacrylate”.

In addition, in the present specification, the “weight average molecular weight (Mw)” is a standard polysterene equivalent value measured by a gel permeation chromatography (GPC) method, and specifically is a value measured based on the method described in Examples.

The mechanism of action described in the present specification is a presumption and does not limit the mechanism exhibiting the effect of the present invention.

### Energy-Ray-Crosslinkable Pressure-Sensitive Adhesive Composition

The energy-ray-crosslinkable pressure-sensitive adhesive composition of an aspect of the present invention is an energy-ray-crosslinkable pressure-sensitive adhesive composition containing a (meth)acrylic resin (A) having no energy ray crosslinkability (hereinafter, also referred to as “energy-ray-non-crosslinkable (meth)acrylic resin (A)” or simply as “component (A)”) and an acrylic resin (B) having energy ray crosslinkability (hereinafter, also referred to as “energy-ray-crosslinkable acrylic resin (B)” or simply as “component (B)”).

The energy-ray-crosslinkable pressure-sensitive adhesive composition (hereinafter, also simply referred to as “pressure-sensitive adhesive composition”) forms a crosslinked pressure-sensitive adhesive by formation of a crosslinked structure caused by irradiation with an energy ray. That is, the pressure-sensitive adhesive composition is a composition that is designed to be irradiated with an energy ray before or after adhering to an adherend.

The pressure-sensitive adhesive composition can be irradiated with the energy ray at a freely chosen time. Thus, the pressure-sensitive adhesive composition has high flexibility in terms of the method of production and method of use thereof.

Specifically, because no intentional crosslinked structure is formed in the pressure-sensitive adhesive composition, the pressure-sensitive adhesive composition can be heated and melted and is also suitable as a hot-melt pressure-sensitive adhesive.

Furthermore, the pressure-sensitive adhesive composition does not have an intentional crosslinked structure and thus has excellent shape conformability. Thus, the pressure-sensitive adhesive composition can be also used for use where the pressure-sensitive adhesive composition is adhered to an adherend with a step or the like and then a crosslinked pressure-sensitive adhesive is formed by energy ray irradiation.

Each component contained in the pressure-sensitive adhesive composition will be described in detail below.

### Energy-Ray-Non-Crosslinkable (Meth)acrylic Resin (A)

The energy-ray-non-crosslinkable (meth)acrylic resin (A) is any (meth)acrylic resin having no energy ray crosslinkability and is not particularly limited.

However, from the viewpoint of suppressing viscosity increase in a case where the pressure-sensitive adhesive composition is kept heated at a high temperature, no radically polymerizable unsaturated double bond is preferably included.

One type of the (meth)acrylic resin (A) having no energy ray crosslinkability may be used alone, or two or more types may be used in combination.

The (meth)acrylic resin (A) having no energy ray crosslinkability is any polymer containing an acrylic monomer as a monomer component and is not particularly limited as long as the polymer has no energy ray crosslinkability but preferably contains a constituent unit derived from an alkyl (meth)acrylate.

As the alkyl (meth)acrylate used in the component (A), for example, an alkyl (meth)acrylate having an alkyl group having from 1 to 18 carbon atoms is suitably used. Specific examples thereof include methyl (meth)acrylate, ethyl (meth)acrylate, propyl (meth)acrylate, n-butyl (meth)acrylate, isobutyl (meth)acrylate, sec-butyl (meth)acrylate, tert-butyl (meth)acrylate, n-pentyl (meth)acrylate, n-hexyl (meth)acrylate, 2-ethylhexyl (meth)acrylate, isooctyl (meth)acrylate, n-decyl (meth)acrylate, n-dodecyl (meth)acrylate, n-tridecyl (meth)acrylate, myristyl (meth)acrylate, palmityl (meth)acrylate, and stearyl (meth)acrylate.

The content of the (meth)acrylic resin (A) having no energy ray crosslinkability in the pressure-sensitive adhesive composition of an aspect of the present invention may be from 40 to 95 mass %, from 50 to 90 mass %, or from 60 to 85 mass %, relative to the entire amount (100 mass %) of the pressure-sensitive adhesive composition.

The glass transition temperature (Tg) of the (meth)acrylic resin (A) having no energy ray crosslinkability is typically 0° C. or lower, preferably −20° C. or lower, and more preferably −30° C. or lower. The glass transition temperature (Tg) of 0° C. or lower facilitates exhibition of pressure-sensitive adhesion performance, the glass transition temperature of −20° C. or lower allows exhibition of adequate adhesive strength when adhesion is performed in a low-temperature environment, and the glass transition temperature of −30° C. or lower allows exhibition of more adequate adhesive strength.

Note that the glass transition temperature (Tg) means a value measured using a differential scanning calorimeter at a heating rate of 20° C./min in accordance with JIS K 7121:1987.

### Energy-Ray-Crosslinkable Acrylic Resin (B)

The energy-ray-crosslinkable acrylic resin (B) is any acrylic resin having energy ray crosslinkability and is not particularly limited.

One type of energy-ray-crosslinkable acrylic resin (B) may be used alone, or two or more types may be used in combination.

Examples of the energy-ray-crosslinkable acrylic resin (B) include an acrylic resin having an energy-ray-reactive group that reacts by energy ray irradiation and contributes to formation of a crosslinked structure.

Examples of the energy-ray-reactive group include a group that is excited by irradiation with an energy ray and generates a radical that triggers a crosslinking reaction.

Specific examples of the energy-ray-reactive group include functional groups having a structure, such as a benzophenone structure, a benzyl structure, an o-benzoylbenzoic ester structure, a thioxanthone structure, a 3-ketocoumarin structure, a 2-ethylanthraquinone structure, and a camphorquinone structure. Among these, the energy-ray-crosslinkable acrylic resin (B) preferably has a benzophenone structure in a side chain.

In the energy-ray-crosslinkable acrylic resin (B) having a benzophenone structure, for example, the benzophenone structure draws a hydrogen atom from a hydrocarbon group contained in a side chain of the acrylic resin by energy ray irradiation, the radicals are recombined, and a crosslinked structure is formed.

The energy-ray-reactive group is preferably introduced into a side chain of the acrylic resin from the viewpoint of facilitating the formation of the crosslinked structure. That is, the energy-ray-crosslinkable acrylic resin (B) is preferably an acrylic resin having a benzophenone structure in a side chain.

The content of the energy-ray-reactive group in the energy-ray-crosslinkable acrylic resin (B) is preferably from 0.02 to 5.0 mass %, and more preferably from 0.05 to 3.0 mass %, relative to a total amount (100 mass %) of the energy-ray-crosslinkable acrylic resin (B).

The acrylic resin is any polymer containing an acrylic monomer as a monomer component and is not particularly limited as long as the polymer has energy ray crosslinkability but preferably contains a constituent unit derived from an alkyl (meth)acrylate.

Examples of the alkyl (meth)acrylate used in the component (B) include methyl (meth)acrylate, ethyl (meth)acrylate, n-propyl (meth)acrylate, n-butyl (meth)acrylate, isobutyl (meth)acrylate, sec-butyl (meth)acrylate, n-hexyl (meth)acrylate, 2-ethylhexyl (meth)acrylate, n-octyl (meth)acrylate, isooctyl (meth)acrylate, n-nonyl (meth)acrylate, isononyl (meth)acrylate, n-decyl (meth)acrylate, and lauryl (meth)acrylate. Among these, alkyl (meth)acrylate is preferably an alkyl (meth)acrylate in which the alkyl group has one or more and eight or less carbon atoms, and is more preferably 2-ethylhexyl (meth)acrylate, methyl (meth)acrylate, or n-butyl (meth)acrylate.

As the method for introducing the energy-ray-reactive group in the component (B), for example, the introduction may be performed by copolymerizing an acrylic monomer with a monomer that has a functional group such as a vinyl group that can react with the acrylic monomer and that contains an energy-ray-reactive group. Furthermore, for example, the introduction may be performed by reacting a compound having the energy-ray-reactive group to a side chain of an acrylic resin by a known method.

The content of the component (B) in the pressure-sensitive adhesive composition is preferably from 5 to 90 parts by mass and, from the viewpoint of adhesiveness, more preferably from 10 to 80 parts by mass, even more preferably from 15 to 50 parts by mass, and yet even more preferably from 15 to 30 parts by mass, per 100 parts by mass of the component (A).

Furthermore, from the viewpoint of readily exhibiting the effect of the present invention, the total content of the component (A) and the component (B) is preferably 60 mass % or greater, more preferably 75 mass % or greater, and even more preferably 90 mass % or greater, and 100 mass % or less, per 100 mass % total of the pressure-sensitive adhesive composition.

The glass transition temperature (Tg) of the energy-ray-crosslinkable acrylic resin (B) is preferably 0° C. or lower, more preferably −20° C. or lower, and even more preferably −30° C. or lower. When the glass transition temperature (Tg) is in this range, adequate adhesive strength can be achieved even when adhesion is performed in a low-temperature environment.

Note that the glass transition temperature (Tg) means a value measured using a differential scanning calorimeter at a heating rate of 20° C./min in accordance with JIS K 7121:1987.

### Other Components

The pressure-sensitive adhesive composition may or may not contain an additional component other than the components described above.

Examples of the additional component include tackifiers; softening agents; antioxidants; and additives for pressure-sensitive adhesives used in a common pressure-sensitive adhesive.

One of these additional components may be used alone, or two or more may be used in combination.

Note that, in the present invention, the pressure-sensitive adhesive composition contains no hydrogen-withdrawing photoinitiator (C) having a low molecular weight (Mw: 1000 or less). In a case where the component (C) is contained, when the components (A), the components (B), or the component (A) and the component (B) are crosslinked by the hydrogen-withdrawing photoinitiator having a low molecular weight, a low-molecular-weight substance, which is a cause of staining of an adherend, is formed as a byproduct due to the radical coupling reaction of the component (C).

Examples of the hydrogen-withdrawing photoinitiator having a low molecular weight include aromatic ketones such as acetophenone, benzophenone, p,p′-dimethoxybenzophenone, 4-methylbenzophenone, p,p′-dichlorobenzophenone, p,p′-dimethylbenzophenone, and acetonaphthone. Other examples thereof include aromatic aldehydes such as terephthalaldehyde and quinone-based aromatic compounds such as methylanthraquinone.

The tackifier is not particularly limited, and a known tackifier can be used. Examples of the tackifier include a rosin-based resin, a terpene-based resin, a petroleum resin, and a styrene-based resin.

The antioxidant is not particularly limited, and a known antioxidant can be used.

Examples of the antioxidant include a hindered phenol-based antioxidant, a sulfur-based antioxidant, and a phosphorus-based antioxidant.

Examples of the aforementioned additive for a pressure-sensitive adhesive used in a common pressure-sensitive adhesive include waxes, fillers, extenders, thermal stabilizers, light stabilizers, ultraviolet absorbers, colorants (such as pigments and dyes), flame retardants, antistatic agents, stringiness retarders, antioxidants, inorganic particles, organic particles, and weight-reducing agents.

For each of these additives for pressure-sensitive adhesives, the additive may be used alone, or two or more types of additives may be used in combination.

In a case where these additives for pressure-sensitive adhesives are contained, each content of an additive for a pressure-sensitive adhesive is independently preferably from 0.0001 to 20 parts by mass, and more preferably from 0.0001 to 10 parts by mass, per 100 parts by mass total of the energy-ray-non-crosslinkable (meth)acrylic resin (A) and the energy-ray-crosslinkable acrylic resin (B).

Furthermore, in a case where the pressure-sensitive adhesive composition contains one or more types selected from the additional components in addition to the component (A) and the component (B), the total content of the component (A) and the component (B) and the one or more types selected from the additional components is preferably 60 mass % or greater, more preferably 70 mass % or greater, even more preferably 80 mass % or greater, and 100 mass % or less, per 100 mass % total of the pressure-sensitive adhesive composition.

### Method for Producing Pressure-Sensitive Adhesive Composition

The pressure-sensitive adhesive composition can be produced, for example, by a method in which the (meth)acrylic resin (A) having no energy ray crosslinkability, the acrylic resin (B) having energy ray crosslinkability, and an optional component used as necessary are melt-kneaded.

Note that, in the following description, the step of melt-kneading the (meth)acrylic resin (A) having no energy ray crosslinkability, the acrylic resin (B) having energy ray crosslinkability, and the like may be referred to as the “melt-kneading step”

The melt-kneading step is, for example, a step of placing the components into a mixing device equipped with a heating device, such as a heating kneader, and mixing the components in a melted state.

Examples of the mixing device equipped with a heating device include a single-screw extruder, a twin-screw extruder, a rolling mill, a Banbury mixer, an intermix, and a pressure kneader.

In a case where a mixing device that can reduce pressure is used, as necessary, the pressure in the inside of the mixing device may be reduced, and the melt-kneading may be performed under reduced pressure.

The kneading temperature in the melt-kneading step is not particularly limited, and a temperature condition under which the components are sufficiently mixed in a melted state is to be appropriately selected. The kneading temperature is preferably from 80 to 180° C., more preferably from 100 to 170° C., and even more preferably from 120 to 150° C.

Note that, in a case where the pressure-sensitive adhesive composition is produced by melt-kneading, the pressure-sensitive adhesive composition does not need to contain a solvent and, from the viewpoint of reducing the environmental load, preferably contains substantially no solvent, and more preferably contains no solvent. Note that, the pressure-sensitive adhesive composition “contains substantially no solvent” means that, for example, the content of the solvent is preferably 0.5 mass % or less, and even more preferably 0.1 mass % or less, per 100 mass % total of the pressure-sensitive adhesive composition.

The pressure-sensitive adhesive composition obtained after completion of the melt-kneading may be applied as is in a heat-melted state on a substrate or a release liner with an extruder or the like, for the production of a pressure-sensitive adhesive sheet of an aspect of the present invention described later, or may be, for example, filled into a container of any of various types or the like without going through a forming step if desired.

### Crosslinked Pressure-Sensitive Adhesive

The crosslinked pressure-sensitive adhesive of an aspect of the present invention is a crosslinked pressure-sensitive adhesive obtained by irradiating the energy-ray-crosslinkable pressure-sensitive adhesive composition of an aspect of the present invention with an energy ray.

That is, the crosslinked pressure-sensitive adhesive has a crosslinked structure formed by an energy ray crosslinking reaction of the energy-ray-crosslinkable acrylic resin (B) contained in the energy-ray-crosslinkable pressure-sensitive adhesive composition.

The crosslinked pressure-sensitive adhesive itself also can have good adhesive strength and exhibit excellent adhesive strength to an adherend. For example, from the viewpoint of making an energy ray irradiation step after adhesion to an adherend unnecessary, an aspect in which the crosslinked pressure-sensitive adhesive is formed by irradiation of the pressure-sensitive adhesive composition with an energy ray prior to adhesion to an adherend, and the crosslinked pressure-sensitive adhesive is adhered to the adherend as a crosslinked pressure-sensitive adhesive may be employed.

The crosslinked pressure-sensitive adhesive can be produced by a method in which the energy-ray-crosslinkable pressure-sensitive adhesive composition is irradiated with an energy ray.

Note that, in the following descriptions, the step of irradiating the energy-ray-crosslinkable pressure-sensitive adhesive composition with an energy ray may be referred to as the “energy ray irradiation step”.

### Pressure-Sensitive Adhesive Sheet

An aspect of the present invention can provide a first pressure-sensitive adhesive sheet and a second pressure-sensitive adhesive sheet described below.

The first pressure-sensitive adhesive sheet is a pressure-sensitive adhesive sheet having an energy-ray-crosslinkable pressure-sensitive adhesive composition layer containing the energy-ray-crosslinkable pressure-sensitive adhesive composition on a substrate or a release liner.

In the following description, “energy-ray-crosslinkable pressure-sensitive adhesive composition layer containing the energy-ray-crosslinkable pressure-sensitive adhesive composition” contained in the first pressure-sensitive adhesive sheet is also simply referred to as “pressure-sensitive adhesive composition layer”.

Furthermore, “pressure-sensitive adhesive layer containing the crosslinked pressure-sensitive adhesive” contained in the second pressure-sensitive adhesive sheet is also simply referred to as “pressure-sensitive adhesive layer”.

Furthermore, when simply referring to “pressure-sensitive adhesive sheet”, both the first pressure-sensitive adhesive sheet and the second pressure-sensitive adhesive sheet are meant.

An example of the configuration of the pressure-sensitive adhesive sheet of an aspect of the present invention will be described below using drawings; however, the pressure-sensitive adhesive sheet is not limited to the following example.

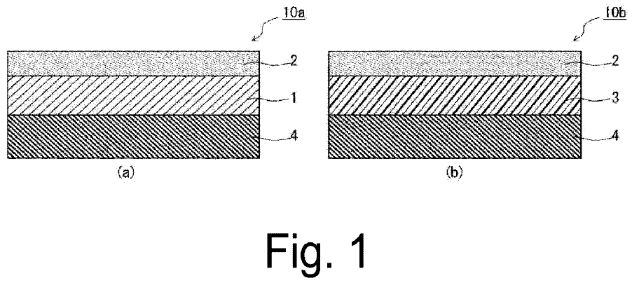

FIG. 1(a) illustrates, as an example of the first pressure-sensitive adhesive sheet, a pressure-sensitive adhesive sheet 10a having: a release liner 2 on one surface side of a pressure-sensitive adhesive composition layer 1; and a substrate 4 on the other surface side of the pressure-sensitive adhesive composition layer 1.

In addition, FIG. 1(b) illustrates, as an example of the second pressure-sensitive adhesive sheet, a pressure-sensitive adhesive sheet 10b having: the release liner 2 on one surface side of a pressure-sensitive adhesive layer 3; and the substrate 4 on the other surface side of the pressure-sensitive adhesive layer 3.

The pressure-sensitive adhesive sheets 10a and 10b are suitable for applications in which, for example, the release liner 2 is peeled off and removed and then the exposed surface of the pressure-sensitive adhesive composition layer 1 or the pressure-sensitive adhesive layer 3 is applied to an adherend. Examples of such use include use for a label.

Note that, in a case where the pressure-sensitive adhesive sheet to be applied to an adherend is the first pressure-sensitive adhesive sheet, a pressure-sensitive adhesive layer containing the crosslinked pressure-sensitive adhesive is formed by irradiating the pressure-sensitive adhesive composition layer with an energy ray after adhesion to the adherend is performed.

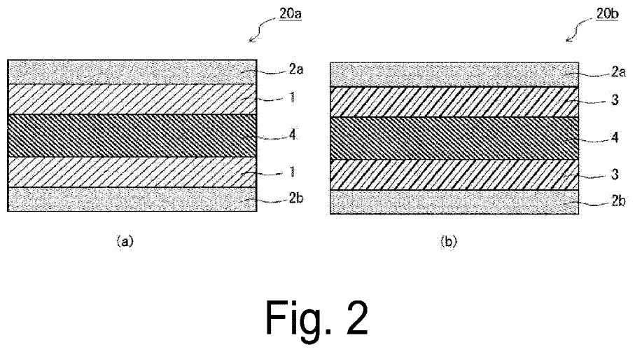

FIG. 2(a) illustrates, as another example of the first pressure-sensitive adhesive sheet, a double-sided pressure-sensitive adhesive sheet 20a having: pressure-sensitive adhesive composition layers 1 on both surfaces of the substrate 4; a release liner 2a on a surface of one pressure-sensitive adhesive composition layer 1, the surface being on the opposite side to the substrate 4; and a release liner 2b on a surface of the other pressure-sensitive adhesive composition layer 1, the surface being on the opposite side to the substrate 4.

In addition, FIG. 2(b) illustrates, as another example of the second pressure-sensitive adhesive sheet, a double-sided pressure-sensitive adhesive sheet 20b having: the pressure-sensitive adhesive layers 3 on both surfaces of the substrate 4; the release liner 2a on a surface of one pressure-sensitive adhesive layer 3, the surface being on the opposite side to the substrate 4; and the release liner 2b on a surface of the other pressure-sensitive adhesive layer 3, the surface being on the opposite side to the substrate 4.

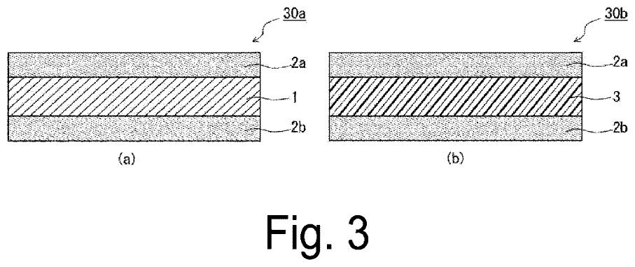

FIG. 3(a) illustrates, as another example of the first pressure-sensitive adhesive sheet, a substrate-less pressure-sensitive adhesive sheet 30a having the release liners 2a and 2b on both sides of the pressure-sensitive adhesive composition layer 1.

FIG. 3(b) illustrates, as another example of the second pressure-sensitive adhesive sheet, a substrate-less pressure-sensitive adhesive sheet 30b having the release liners 2a and 2b on both surfaces of the pressure-sensitive adhesive layer 3.

The pressure-sensitive adhesive sheets 20a, 20b, 30a, and 30b are suitable for bonding adherends together, in which, for example, the release liner 2a on one surface side is peeled off and removed, then the exposed surface of the pressure-sensitive adhesive composition layer 1 or the pressure-sensitive adhesive layer 3 is applied to an adherend, then the release liner 2b is further peeled off and removed, and then the exposed surface of the pressure-sensitive adhesive composition layer 1 or the pressure-sensitive adhesive layer 3 is applied to another adherend. Examples of such applications include applications for fixing or temporarily fixing various components.

In the pressure-sensitive adhesive sheets 30a and 30b, in the case where the peeling force for peeling off the release liner 2a from the pressure-sensitive adhesive composition layer 1 or the pressure-sensitive adhesive layer 3 is approximately the same as the peeling force for peeling off the release liner 2b from the pressure-sensitive adhesive composition layer 1 or the pressure-sensitive adhesive layer 3, an attempt to peel off both release liners by pulling them outward may result in a phenomenon where the pressure-sensitive adhesive composition layer 1 or the pressure-sensitive adhesive layer 3 is divided along with the two release liners and peeled off. From the viewpoint of suppressing such a phenomenon, two release liners designed to have different peeling forces are preferably used as the two release liners 2a and 2b.

The thickness of the pressure-sensitive adhesive composition layer in the first pressure-sensitive adhesive sheet and the thickness of the pressure-sensitive adhesive layer in the second pressure-sensitive adhesive sheet are each independently preferably from 5 to 100 μm, more preferably from 10 to 60 μm, and even more preferably from 15 to 30 μm.

With a thickness of 5 μm or greater, the pressure-sensitive adhesive composition layer and the pressure-sensitive adhesive layer tend to facilitate further improvement of the adhesive strength. Furthermore, when the thickness of the pressure-sensitive adhesive composition layer or the pressure-sensitive adhesive layer is 100 μm or less, even better handleability tends to be achieved.

### Substrate

Examples of a material forming the substrate include resins, metals, and paper materials.

Examples of the resin include a polyolefin resin such as polyethylene and polypropylene; a vinyl-based resin such as polyvinyl chloride, polyvinylidene chloride, polyvinyl alcohol, an ethylene-vinyl acetate copolymer, and an ethylene-vinyl alcohol copolymer; a polyester-based resin such as polyethylene terephthalate, polybutylene terephthalate, and polyethylene naphthalate; polystyrene; an acrylonitrile-butadiene-styrene copolymer; cellulose triacetate; polycarbonate; a urethane resin such as polyurethane and acrylic-modified polyurethane; polymethylpentene; polysulfone; polyether ether ketone; polyethersulfone; polyphenylene sulfide; a polyimide-based resin such as polyetherimide and polyimide; a polyamide-based resin; an acrylic resin; and a fluororesin.

Examples of the metal include aluminum, tin, chromium, and titanium.

Examples of the paper material include tissue paper, wood-containing paper, wood-free paper, impregnated paper, coat paper, art paper, vegetable parchment, and glassine paper.

The material forming the substrate may be composed of one material, or two or more of the materials may be used in combination.

Examples of the substrate in which two or more formation materials are used in combination include a material obtained by laminating a paper material with a thermoplastic resin such as polyethylene, and a material obtained by forming a metal film on a surface of a resin film or sheet containing a resin. Note that examples of a method of forming a metal layer include a method of subjecting the metal described above to vapor deposition by a PVD method, such as vacuum deposition, sputtering, or ion plating; or a method of adhering a metal foil made of the metal described above using a typical pressure-sensitive adhesive.

Note that, from the viewpoint of improving interlayer adhesion of the substrate and another layer to be layered, in a case where the substrate contains a resin, surface treatment by an oxidation method, a roughening method, or the like, or primer treatment may be performed to a surface of the substrate.

According to the application of the pressure-sensitive adhesive sheet, the substrate may have, for example, an ink receptive layer; a recording layer for enabling recording, such as thermal transfer recording and ink-jet recording; an overcoat film or an overlaminate film for protecting these surfaces; and/or an information region, such as a magnetic recording, a bar code, or a micro semiconductor device.

On the other hand, when the pressure-sensitive adhesive sheet is formed as a transparent pressure-sensitive adhesive sheet with transparency, the substrate preferably has transparency.

The substrate may contain an additive for a substrate as necessary. Examples of the additive for a substrate include an ultraviolet absorber, a light stabilizer, an antioxidant, an antistatic agent, a slip agent, an antiblocking agent, and a colorant. These additives for substrates may each be used alone or in combination of two or more types.

The thickness of the substrate is preferably from 5 to 1000 μm, more preferably from 15 to 500 μm, and even more preferably from 20 to 200 μm.

When the thickness of the substrate is 5 μm or greater, deformation resistance of the pressure-sensitive adhesive sheet tends to be improved. On the other hand, with a thickness of 1000 μm or less, the substrate tends to facilitate the improvement of the handling properties of the pressure-sensitive adhesive sheet.

Note that the “thickness of the substrate” means a thickness of the entire substrate and, in a case where the substrate contains a plurality of layers, means the total thickness of all the layers constituting the substrate.

### Release Liner

For the release liner, a release liner subjected to double-sided release treatment, a release liner subjected to single-sided release treatment, or the like is used. Examples include a release liner obtained by applying a release agent on a substrate for a release liner.

Examples of the substrate for a release liner include paper, such as wood-free paper, glassine paper, and kraft paper; and plastic films, such as polyester resin films of a poly (ethylene terephthalate) resin, a poly (butylene terephthalate) resin, a poly (ethylene naphthalate) resin, or the like, and polyolefin resin films of a polypropylene resin, a polyethylene resin, or the like.

Examples of the release agent include a rubber-based elastomer, such as a silicone-based resin, an olefin-based resin, an isoprene-based resin, and a butadiene-based resin; a long-chain alkyl-based resin; an alkyd-based resin; and a fluorine-based resin.

The thickness of the release liner is not particularly limited as long as the effects of the present invention are not impaired, but the thickness is preferably from 10 to 200 μm, more preferably from 20 μm to 180 μm, and even more preferably from 30 μm to 150 μm.

### Method for Producing First Pressure-Sensitive Adhesive Sheet

The method for producing the first pressure-sensitive adhesive sheet is, for example, a method for producing the pressure-sensitive adhesive sheet where the pressure-sensitive adhesive composition is obtained by melt-kneading the (meth)acrylic resin (A) and the acrylic resin (B) having energy ray crosslinkability; and the energy-ray-crosslinkable pressure-sensitive adhesive composition layer is formed by applying the energy-ray-crosslinkable pressure-sensitive adhesive composition in a melted state on the substrate or the release liner.

In the following descriptions, the step of forming the energy-ray-crosslinkable pressure-sensitive adhesive composition layer by applying the energy-ray-crosslinkable pressure-sensitive adhesive composition in a melted state on the substrate or the release liner may be referred to as the “pressure-sensitive adhesive composition layer-forming step”

Furthermore, in the present specification, “on the release liner” refers to “on the release-treated surface” in a case of a release liner that has undergone a single-sided release treatment.

In the method for producing the first pressure-sensitive adhesive sheet, the description of the step of melt-kneading the (meth)acrylic resin (A) and the acrylic resin (B) having energy ray crosslinkability is the same as the description of the melt-kneading step in the method for producing the pressure-sensitive adhesive composition of an aspect of the present invention.

The pressure-sensitive adhesive composition layer-forming step may be a method in which the energy-ray-crosslinkable pressure-sensitive adhesive composition obtained after completion of melt-kneading is applied, while still in a heat-melted state, on a substrate or a release liner using an extruder, a T-die, and the like to form a layer. Thereafter, as necessary, cooling of the pressure-sensitive adhesive composition layer may be performed.

The pressure-sensitive adhesive composition layer can be formed on the substrate or the release liner by the above pressure-sensitive adhesive composition layer-forming step.

The sheet with the substrate or the release liner and the pressure-sensitive adhesive composition layer may be used as is as the first pressure-sensitive adhesive sheet of an aspect of the present invention or may be subjected to an additional step as necessary to configure a desired pressure-sensitive adhesive sheet.

For example, a pressure-sensitive adhesive sheet having a release liner on one surface side of a pressure-sensitive adhesive composition layer and having a substrate on the other surface side of the pressure-sensitive adhesive composition layer as in the pressure-sensitive adhesive sheet 10a illustrated in FIG. 1(a) can be produced by applying the release-treated surface of the release liner to the exposed surface of the pressure-sensitive adhesive composition layer formed on the substrate.

In addition, as in the pressure-sensitive adhesive sheet 20a illustrated in FIG. 2(a), a double-sided pressure-sensitive adhesive sheet having pressure-sensitive adhesive composition layers on both surfaces of a substrate and having a release liner on the surface of each pressure-sensitive adhesive composition layer, the surface being on the opposite side to the substrate, can be produced by applying the substrate surface of the pressure-sensitive adhesive sheet 10a to the exposed surface of the pressure-sensitive adhesive composition layer formed on the release liner.

Alternatively, a substrate-less pressure-sensitive adhesive sheet having release liners on both surfaces of the pressure-sensitive adhesive composition layer as in the pressure-sensitive adhesive sheet 30a illustrated in FIG. 3(a) can be produced by applying the release-treated surface of one release liner to the exposed surface of the pressure-sensitive adhesive composition layer formed on another release liner.

### Method for Producing Second Pressure-Sensitive Adhesive Sheet

A method for producing the second pressure-sensitive adhesive sheet is, for example, a method for producing the pressure-sensitive adhesive sheet including:

forming an energy-ray-crosslinkable pressure-sensitive adhesive composition layer containing the energy-ray-crosslinkable pressure-sensitive adhesive composition on the substrate or the release liner; and irradiating the energy-ray-crosslinkable pressure-sensitive adhesive composition layer with an energy ray.

In the method for producing the second pressure-sensitive adhesive sheet, the description of the step of forming an energy-ray-crosslinkable pressure-sensitive adhesive composition layer is the same as the description of the step of forming a pressure-sensitive adhesive composition layer in the method for producing the first pressure-sensitive adhesive sheet.

In the irradiation of the energy-ray-crosslinkable pressure-sensitive adhesive composition layer with an energy ray of the method for producing the second pressure-sensitive adhesive sheet, the timing at which the energy ray irradiation is performed is not particularly limited and is appropriately determined in consideration of the method for producing the pressure-sensitive adhesive sheet, desired physical properties, and the like.

For example, in a state where one surface of the pressure-sensitive adhesive composition layer is exposed, the pressure-sensitive adhesive composition layer may be irradiated with an energy ray directly or through the substrate or the release liner, or in a state where the pressure-sensitive adhesive composition layer has the substrate or the release liner on one surface and the release liner on the other surface, the pressure-sensitive adhesive composition layer may be irradiated with an energy ray through the substrate or the release liner.

Furthermore, the energy ray irradiation may be performed once or for a plurality of times. When the energy ray irradiation is performed multiple times, for example, the first energy ray irradiation may be performed in a state where one surface of the pressure-sensitive adhesive composition layer is exposed, then the substrate or the release liner is applied to the surface, and then the second energy ray irradiation may be performed through the substrate or the release liner.

Alternatively, the first energy ray irradiation may be performed at any time before the application to the adherend, and the second energy ray irradiation may be performed after the application to the adherend.

### Use of Energy-Ray-Crosslinkable Pressure-Sensitive Adhesive Composition, Crosslinked Pressure-Sensitive Adhesive, and Pressure-Sensitive Adhesive Sheet

The energy-ray-crosslinkable pressure-sensitive adhesive composition, crosslinked pressure-sensitive adhesive, and pressure-sensitive adhesive sheet of an aspect of the present invention can be used for various applications.

Specific examples include label applications; applications for fixing or temporarily fixing various components; surface protection applications; sealing material applications; and decoration and display applications.

Among these, label applications and applications for fixing or temporarily fixing various components are preferred.

The pressure-sensitive adhesive sheet for label applications may be directly adhered to various products or may be adhered to packaging films and packaging containers of various products, and the like. Examples of the constitutional material of the packaging film and the packaging container include an olefin-based resin such as polypropylene and polyethylene; a polyester-based resin such as polyethylene terephthalate (PET) and polylactic acid; glass, paper, and metal.

Among these, because the pressure-sensitive adhesive sheet of an aspect of the present invention is less likely to leave a mark on an adherend after releasing, the pressure-sensitive adhesive sheet is suitable for use for application to various products, packaging containers, and the like made of glass, a metal, a polyester-based resin, or the like.

The pressure-sensitive adhesive sheet for applications for fixing or temporary fixing is suitable for fixing or temporarily fixing, for example, electronic members, optical members, automobile components, mechanism components, construction members, or decorative members.

### EXAMPLES

The present invention will be specifically described with reference to Examples below, but the present invention is not limited to the following Examples. Physical property values in examples are values measured by the following methods.

### Weight Average Molecular Weight (Mw)

The weight average molecular weight (Mw) is a standard polystyrene equivalent value measured under the following conditions using a gel permeation chromatograph.

### Measurement Instrument

Measurement instrument: product name “HLC-8320GPC”, available from Tosoh Corporation
Detector: differential refractometer.
Columns: one “TSK guard column super H-H”, two “TSK gel super HM-H” connected in series, and one “TSK gel super H2000” (all available from Tosoh Corporation) were connected in this order from a feed port side of the measurement sample.

### Measurement Conditions

Column temperature: 40° C.
Developing solvent: tetrahydrofuran
Flow rate: 1.0 mL/min

### Glass Transition Temperature (Tg)

The glass transition temperature (Tg) was measured by using a differential scanning calorimeter in accordance with JIS K 7121:1987.

### Measurement Sample Mass

10 mg

### Measurement INSTRUMENT

Measurement instrument: product name “DSC Q2000”, available from TA Instruments Japan Inc.

### Measurement Conditions

Measurement temperature range: from −80° C. to 50° C.
Rate of temperature increase: 20° C./min

### Thickness of Each Layer

The thickness of each layer was measured at 23° C. by using a constant pressure thickness meter (model number: “PG-02J”, standard specifications: in accordance with JIS K 6783, Z 1702, and Z 1709) available from Teclock Co., Ltd.

Details of the materials used in the following Examples and Comparative Example are shown below.

### Energy-Ray-Non-Crosslinkable (Meth)acrylic Resin (A)

(Meth)acrylic resin: P(BA): poly (n-butyl acrylate); weight average molecular weight Mw: 700,000

### Energy-Ray-Crosslinkable Acrylic Resin (B)

Energy-ray-crosslinkable acrylic resin: acrylic resin having a benzophenone structure in a side chain, available from BASF, trade name “acResin A204UV” Additional Component
Photoinitiator: 4-methylbenzophenone (product name “SpeedCure MBP”, available from Lambson)

### Examples 1 to 3 and Comparative Examples 1 and 2

### Production of Energy-Ray-Crosslinkable Pressure-Sensitive Adhesive Composition

The component (A) and the component (B) were blended according to the composition (unit: parts by mass) shown in Table 1 and kneaded at 130° C. for 20 minutes under a nitrogen purge using a heating kneader, and an energy-ray-crosslinkable pressure-sensitive adhesive composition was obtained.

### Production of First Pressure-Sensitive Adhesive Sheet

The energy-ray-crosslinkable pressure-sensitive adhesive composition obtained in the above was applied in a heat-melted state on a transparent poly (ethylene terephthalate) film (thickness: 50 μm) used as a substrate using a die coater. Thus, a first pressure-sensitive adhesive sheet having an energy-ray-crosslinkable pressure-sensitive adhesive composition layer (thickness: 20 μm) containing the energy-ray-crosslinkable pressure-sensitive adhesive composition on the substrate was obtained.

### Production of Second Pressure-Sensitive Adhesive Sheet

The energy-ray-crosslinkable pressure-sensitive adhesive composition layer of the first pressure-sensitive adhesive sheet obtained above was irradiated with ultraviolet light from the exposed surface side using a high-pressure mercury lamp (available from Eye Graphics Co., Ltd.) under a condition of an integrated amount of light of 30 mJ/cm² in the UV-C region. Thus, a pressure-sensitive adhesive layer was formed by energy ray crosslinking the energy-ray-crosslinkable pressure-sensitive adhesive composition layer included in the first pressure-sensitive adhesive sheet. Then, a release-treated surface of a release liner (thickness: 38 μm) was bonded to the surface of the pressure-sensitive adhesive layer, the surface being on the opposite side to the substrate, and a second pressure-sensitive adhesive sheet having the substrate, the pressure-sensitive adhesive layer, and the release liner in this order was obtained.

### Evaluation Method

The second pressure-sensitive adhesive sheet obtained in each example was evaluated by the methods described below.

### Measurement of Adhesive Strength

After the release liner was peeled off from the pressure-sensitive adhesive sheet obtained in each of Examples and Comparative Examples, the exposed pressure-sensitive adhesive surface was pressure-bonded to a stainless steel plate used as an adherend at room temperature (23° C.) by reciprocating a 2-kg roller once in accordance with JIS Z 0237:2009. After pressure-bonding, the material was allowed to stand in an environment of 23° C. and 50% RH (relative humidity) for 30 minutes and obtained as a sample for adhesive strength measurement.

The sample for adhesive strength measurement prepared as described above was measured for adhesive strength at a tensile speed of 300 mm/min by a 180° peeling method in accordance with JIS Z 0237:2009 using a tensile tester (available from A & D Company, Limited, product name “Tensilon (trade name)”) in an environment of 23° C. and 50% RH (relative humidity).

### Evaluation of Staining of Adherend

Each of the second pressure-sensitive adhesive sheets produced in Examples and Comparative Examples was cut into a size of 25 mm×50 mm in an environment at 23° C. and 50% RH (relative humidity), and two test pieces were prepared. The release liner of each of the test pieces was removed, and the exposed pressure-sensitive adhesive layer was attached to an adherend (stainless steel plate).

Then, the test piece attached to the adherend was allowed to stand in an environment of 70° C. for 7 days, and then allowed to stand in an environment of 23° C. and 50% RH for 1 day. In an environment of 23° C. and 50% RH, one of the test pieces was peeled off from the adherend by hands at a speed of approximately 300 mm/min in a 180° direction (low-speed peeling). In addition, the other one of the test pieces was peeled off by hand at a speed of approximately 30 m/min in a 180° direction (high-speed peeling). The state of the layer of the pressure-sensitive adhesive layer of the test piece after the peeling was visually observed, and staining of the adherend was checked based on the following criteria.

No staining: The peeling occurred at the interface between the pressure-sensitive adhesive layer and the adherend, no pressure-sensitive adhesive remained on the adherend, and no difference was observed compared with an unattached portion.

Cloudiness: Although the peeling occurred at the interface between the pressure-sensitive adhesive layer and the adherend, the attached portion was observed to be whiter than an unattached portion.

Cohesive failure: The pressure-sensitive adhesive layer was broken, and remainder of the pressure-sensitive adhesive layer was observed to be on the adherend.

TABLE 1

| | | | | Examples | | | Comparative Examples | |
|---|---|---|---|---|---|---|---|---|
| | | | Unit | 1 | 2 | 3 | 1 | 2 |
| Composition | Component | (Meth)acrylic resin | Parts by | 100 | 100 | 100 | 100 | 100 |
| of pressure- | (A) | (Poly(butyl acrylate) Mw: 700,000; | mass | | | | | |
| sensitive | | Tg: −55° C.) | | | | | | |
| adhesive | Component | Energy-ray-crosslinkable acrylic | Parts by | 20 | 80 | 90 | — | — |
| composition | (B) | resin (A204UV Tg: −34° C.) | mass | | | | | |
| | Additional | Photoinitiator | Parts by | — | — | — | 8 | — |
| | component | (4-Methylbenzophenone) | mass | | | | | |

| | | | | | | | |
|---|---|---|---|---|---|---|---|
| Evaluation | Adhesive strength (23° C.) | [N/25 mm] | 13.5 | 12.5 | 9.5 | 12.0 | 25.0 |
| results | Staining of adherend | — | None | None | None | Cloudiness | Cohesive |

failure
Tg: Glass transition temperature

As can be seen from Table 1, the pressure-sensitive adhesive sheet obtained in each of Examples 1 to 3 caused no attachment mark (cloudiness) of the pressure-sensitive adhesive sheet, caused no cohesive failure, and caused no staining of the adherend in the evaluation of staining of the adherend while good adhesive strength was achieved.

On the other hand, the pressure-sensitive adhesive sheet of Comparative Example 1, in which no acrylic resin (B) having energy ray crosslinkability was used but a photoinitiator was used instead, caused an attachment mark (cloudiness) of the pressure-sensitive adhesive sheet. Furthermore, the pressure-sensitive adhesive sheet of Comparative Example 2, in which no acrylic resin (B) having energy ray crosslinkability was used, caused cohesive failure.
1 Energy-ray-crosslinkable pressure-sensitive adhesive composition layer
2, 2a, 2b Release liner
3 Pressure-sensitive adhesive layer
4 Substrate
10a, 20a, 30a First pressure-sensitive adhesive sheet
10b, 20b, 30b Second pressure-sensitive adhesive sheet

1. An energy-ray-crosslinkable pressure-sensitive adhesive composition, comprising:
a (meth)acrylic resin (A) having no energy ray crosslinkability; and
an acrylic resin (B) having energy ray crosslinkability.

2. The composition of claim 1, wherein a content of the acrylic resin (B) is in a range of from 5 to 90 parts by mass, per 100 parts by mass of the (meth)acrylic resin (A).

3. The composition of claim 1, wherein the acrylic resin (B) is an acrylic resin having a benzophenone structure in a side chain.

4. The composition of claim 1, wherein a glass transition temperature of the (meth)acrylic resin (A) having no energy ray crosslinkability is 0° C. or lower, and
wherein a glass transition temperature of the acrylic resin (B) is 0° C. or lower.

5. A pressure-sensitive adhesive sheet, comprising:
an energy-ray-crosslinkable pressure-sensitive adhesive composition layer comprising the energy-ray-crosslinkable pressure-sensitive adhesive composition of claim 1 on a substrate or a release liner.

6. The method of claim 5, wherein the energy-ray-crosslinkable pressure-sensitive adhesive composition is obtained by melt-kneading the (meth)acrylic resin (A) having no energy ray crosslinkability and the acrylic resin (B) having energy ray crosslinkability, and
wherein the energy-ray-crosslinkable pressure-sensitive adhesive composition layer is formed by applying the energy-ray-crosslinkable pressure-sensitive adhesive composition in a melted state on the substrate or the release liner.

7. A crosslinked pressure-sensitive adhesive, obtained by irradiating the energy-ray-crosslinkable pressure-sensitive adhesive composition of claim 1 with an energy ray.

8. A method for producing the crosslinked pressure-sensitive adhesive of claim 7, the method comprising:
irradiating the energy-ray-crosslinkable pressure-sensitive adhesive composition with an energy ray.

9. A pressure-sensitive adhesive sheet, comprising:
a pressure-sensitive adhesive layer comprising the crosslinked pressure-sensitive adhesive of claim 7 on a substrate or a release liner.

10. A method for producing the pressure-sensitive adhesive sheet of claim 9, the method comprising:
forming an energy-ray-crosslinkable pressure-sensitive adhesive composition layer containing the energy-ray-crosslinkable pressure-sensitive adhesive composition on the substrate or the release liner; and
irradiating the energy-ray-crosslinkable pressure-sensitive adhesive composition layer with an energy ray.

11. The method of claim 10, wherein the energy-ray-crosslinkable pressure-sensitive adhesive composition is obtained by melt-kneading the (meth)acrylic resin (A) having no energy ray crosslinkability and the acrylic resin (B) having energy ray crosslinkability, and
wherein the energy-ray-crosslinkable pressure-sensitive adhesive composition layer is formed by applying the energy-ray-crosslinkable pressure-sensitive adhesive composition in a melted state on the substrate or the release liner.
